(19) United States
(12) Patent Application Publication
(10) Pub. No.: US 2011/0244831 A1
(43) Pub. Date: Oct. 6, 2011

(54) METHOD AND SYSTEM FOR PROCESSING UE STATUS INFORMATION AND MANAGING ALERTS IN TELECOMMUNICATION NETWORK

(75) Inventors: Rajiv Rajan AZHAPILLI, Staines (GB); Craig Bishop, Staines (GB)

(73) Assignee: Samsung Electronics Co., Ltd., Suwon-si (KR)

(21) Appl. No.: 13/050,360

(22) Filed: Mar. 17, 2011

(30) Foreign Application Priority Data
Mar. 17, 2010 (GB) 1004444.4
Mar. 4, 2011 (KR) 10-2011-0019351

(51) Int. Cl. H04L 12/58; H04W 36/00

(52) U.S. Cl. 455/412.1; 455/436

(57) ABSTRACT

Disclosed is a method of processing User Equipment (UE) status information in a telecommunication network including a plurality of RANs, first UE and second UE, the method including: sending a first message via the telecommunication network, the first message containing a request originated by the first UE and requesting status information relating to the second UE; and receiving a second message via the telecommunication network, the second message conveying the requested status information, wherein at least one of said first and second messages are processed using a service component which is used for controlling handover of UE between different RANs.

### PRIORITY

This application claims priority under 35 U.S.C. §119(a) to a Application filed in the Korean Intellectual Property Office on Mar. 4, 2011 and assigned Serial No. 10-2011-0019351 and an Application filed in the Great Britain Intellectual Property Office on Mar. 17, 2010 and assigned Serial No. GB 1004444.4, the entire disclosure of which is incorporated herein by reference.

### FIELD OF THE INVENTION

The present invention relates generally to telecommunications networks, and more particularly, to methods and apparatus for avoiding an inconvenient alert to a called party.

### BACKGROUND OF THE INVENTION

Wireless networks, in which a User Equipment (UE) such as a mobile handset communicates via wireless links to a network of base stations or other wireless access points connected to a telecommunications network, have undergone rapid development through a number of generations of radio access technology. Furthermore, wireless networks have evolved via separate routes in the fields of cellular wireless, such as Global System for Mobile communications (GSM), Universal Mobile Telecommunications System (UMTS) and Long Term Evolution (LTE), fixed wireless access (such as IEEE 802.16 WiMAX), and wireless networking (such as IEEE 802.11 WiFi), to the point where the technologies potentially offer similar capabilities, including mobility. A telecommunications network may comprise several Radio Access Networks (RANs), each using a different radio access technology. In some locations the areas of coverage may overlap, but typically the coverage of deployed wireless networks is not ubiquitous, and the capabilities of a wireless network, in particular regarding available data bandwidth, vary depending on the location. In particular, WiFi may offer potentially high bandwidth in relatively localized areas such as “hotspots,” but limited or no coverage elsewhere. To the contrary, cellular wireless systems offer typically greater coverage, but typically more limited data bandwidth.

UE has been developed for use in a telecommunication network including a plurality of RANs, equipped with radio transceivers appropriate for a variety of radio access technologies. The UE is able to select a RAN appropriate to its requirements according to the capabilities available at a given location, and to handover to another RAN if the location of the UE or the capabilities of the RANs changes.

Systems and protocols have been developed to assist handover between wireless networks operating using different radio access technologies, such as IEEE 802.21 Media Independent Handover (MIH). Although MIH is typically used for assisting handover of UE between RANs operating according to different radio access technologies, MIH may also be used for handover between RANs using the same radio access technology, or between access nodes within a RAN.

MIH may typically be implemented without changing the existing RANs, other than by the installation of MIH clients in network entities such as UE and wireless access nodes, and provision of the MIH server. The MIH server may also be referred to as a MIH information server.

Messages in the MIH system are relayed between entities known as MIH Functions (MIHF). An MIHF has a (MIHF ID), which may for example be a MAC address or an IP address. The MIHF is located between layer 2 and layer 3 of the OSI protocol stack, and communication is provided between the various wireless functions (layer 2) and MIHFs, between MIHFs, and between MIHFs and entities in the IP layer (layer 3).

MIH messages may be sent in connection with three specified media independent services: Event Service (ES), Command Service (CS) and Information Service (IS). The Event Service provides a unified reporting mechanism relating to changes in state or status of the link layers. The Command Service (CS) allows either the UE client or the MIH server to control the parameters of a link, modify the behavior of the ES and initiate and coordinate network switching. The Information Service provides database access and retrieval of information relating to network availability, network parameters and the availability of services for both serving and neighboring access networks. Examples of information carried by the Information Service include geographical network maps, service costs, quality of service functionalities and roaming partners. The Information Service also provides neighboring network information about user and network operator policies for optimal initial network attachment or network re-selection in idle mode.

Handover using MIH may be implemented according to various control models. In one approach, handover may be terminal controlled, i.e., control is implemented in the MIH client installed in a UE. In this case, the UE may make use of all three MIH services (ES, CS and IS).

Alternatively, handover may be terminal initiated, and network assisted. In this case, the UE makes use of the Information Service.

According to a third control model, handover may be network initiated and network controlled, in which case the network makes use of the MIH Event Service, Command Service and Information Service to decide whether handover is needed, to decide the target (i.e. the wireless access point or base station to which handover should be made) and to command the terminal to handover. In this approach, the UE does not use the MIH Information Service.

In either the terminal controlled handover model, or terminal initiated handover model, the MIH information server may typically supply information to the MIH client at the UE relating to:
network types available given the location of the UE;
location of wireless access points and base stations;
identifiers of network providers;
information relating to roaming agreements between network operators, indications of costs for network usage according to service type;
link layer security supported;
link quality of service parameters;
capabilities of an access point or base station such as emergency services;
Internet Protocol Multimedia Subsystem (IMS) services; and
operator specific information elements.

It can be seen that the MIH Information Service is not used to convey status information relating to a UE to another UE in any of the approaches to handover, since such information is not relevant to a handover decision. Further, a UE is not supplied information relating to the status of other UEs by use of any other MIH service.

In a telecommunication system including a plurality of RANs, the RANs may cover differing time zones, so that a called party may be roaming in a location at which the local time is an inconvenient time to receive an alert of a call, such as at night, unknown to the caller. Additionally, a called party may wish not to be alerted for a variety of reasons. It would be beneficial to provide a method and apparatus that would enable a caller to avoid an inconvenient alert to a called party, for use in a telecommunications network including a plurality of RANs.

### SUMMARY OF THE INVENTION

According to an aspect of the present invention, a method of processing UE status information in a telecommunication network including a plurality of RANs, a first UE, and a second UE is provided, the method including sending a first message via the telecommunication network, the first message containing a request originated by the first UE and requesting status information relating to the second UE; and receiving a second message via the telecommunication network, the second message conveying the requested status information, wherein at least one of the first and second messages are processed using a service component which is used for controlling handover of UE between different RANs.

According to another aspect of the present invention, a method of managing alerts in a telecommunications network is provided, the method including setting a status indicator relating to second UE; detecting initiation of a call to the second UE by a caller from first UE; dependent on the status indicator, selecting an alerting tone for use in the first UE; and dependent on the status indicator, delaying generation of an alert for use in the second UE in order to allow the caller to decide whether or not to abort the call to the second UE before generating the alert in the second UE.

According to yet another aspect of the present invention, a method in a telecommunications system is provided, including setting a status indicator relating to second User Equipment (UE); detecting initiation of a call to the second UE by a caller from first UE; selecting an alerting tone for use in the first UE, dependent on the status indicator; and delaying generation of an alert for use in the second UE in order to allow the caller to decide whether or not to abort the call to the second UE before generating the alert in the second UE, depending on the status indicator.

### BRIEF DESCRIPTION OF THE DRAWINGS

FIGS. 1A and 1B are diagrams illustrating a telecommunication network including MIH entities;

FIG. 2 is a diagram illustrating transmission of messages according to a first embodiment of the invention;

FIG. 3 is a diagram illustrating transmission of messages according to a second embodiment of the invention;

FIG. 4 is a diagram illustrating transmission of messages according to a third embodiment of the invention;

FIG. 5 is a diagram illustrating transmission of messages according to a fourth embodiment of the invention; and;

FIG. 6 is a diagram illustrating transmission of messages according to a fifth embodiment of the invention.

### DETAILED DESCRIPTION OF EMBODIMENTS OF THE PRESENT INVENTION

By way of example, embodiments of the invention will now be described in the context of a telecommunication network that includes one or more cellular RANs and also includes wireless hotspots that are part of a RAN such as a WiFi network supporting IEEE 802.11 radio access technology. The one or more cellular RANs may be GSM, UMTS or LTE networks, or a combination of these, using GERA, UTRA and E-UTRA radio access technology, respectively. However, it will be understood that these are merely examples and that other embodiments may involve wireless networks using other radio access technologies, such as WiMAXx networks supporting IEEE 802.16 radio access technology; embodiments are not limited to the use of a particular radio access technology. Embodiments are described using MIH to assist handover between these RANs. However, it will be understood that other service components for controlling handover between different RANs could be used in embodiments of the invention, such as Unlicensed Mobile Access (UMA), also known as Generic Access Network (GAN), which provides handover between IEEE 802.11 WiFi and GERA/UTRA.

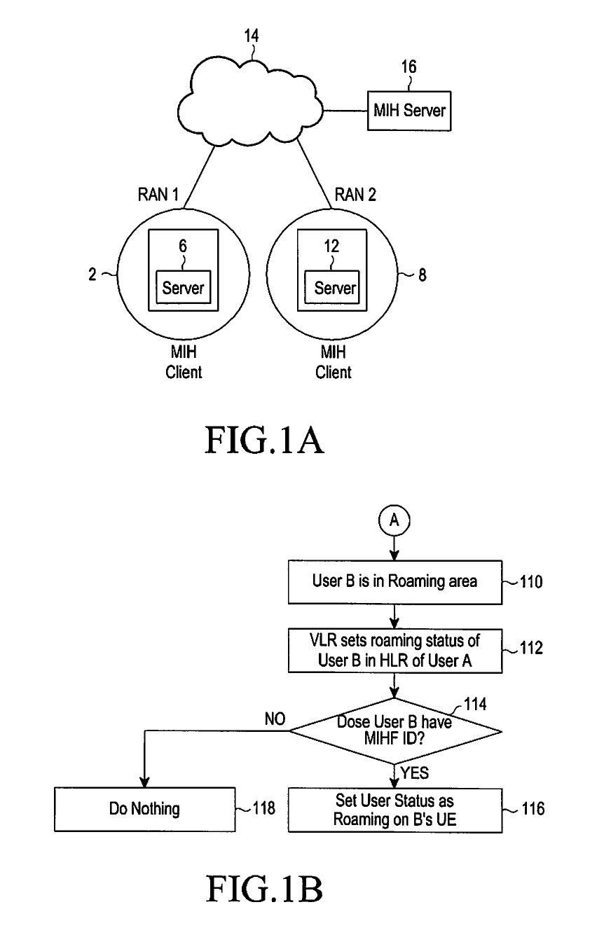

The embodiments of the invention will be described with reference to FIGS. 1A and 1B, which shows a telecommunication network including MIH entities. A first UE 2 is camped in a first Radio Access Network (RAN) 1, and a second UE 8 is camped in a second RAN 12, which may be located in a different time zone than the first RAN 1. The first RAN 1 may be a UMTS network, and the second RAN 12 may be a WiFi network; the second UE may be connected to a local WiFi hotspot in the second RAN 12, for example, to take advantage of high-speed data services. The first and second RANs are connected to an interconnecting network 14. The first UE 2 has a MIH client 6 installed, and the second UE 8, similarly, has a MIH client 10 installed. An MIH server or server system 16 is connected to the interconnecting network 14, so that the MIH clients may access the MIH server or server system 16 using the telecommunication network, typically by using the Internet Protocol (IP).

A user A, being the user of the first UE 2, intends to call user B, who is the user of the second UE 8. At this point, user A would like to obtain status information regarding the UE of user B, in order to avoid causing an inconvenient alert to user B; user A does not know, in this example, the location or time zone in which the second UE is located or whether or not user B has set the second UE to indicate a contactability preference, for example, a preference to receive urgent calls only.

User A selects the entry for user B from an address book, which stores address information, typically held at the first UE 2. The address information may, in another embodiment, be retrieved from other entities in the telecommunication network. The address information conventionally includes a telephony party identifier such as a telephone number, relating to a user and/or a UE. However, according to the first embodiment of the invention the address book may also hold MIHF IDsrelating to UE and/or the user in addition to the telephony party identifier. Attempting to retrieve the MIHF ID from the address book has the function of firstly indicating whether or not the UE to be called, in this example the second UE 8, has a MIH client installed, and if so, of providing an address to enable a message to be sent to the MIHF of the second UE 8.

If the second UE 8 has an MIHF ID, and the first UE 2 has an MIHF client 6 installed, a first message is sent from the first UE 2 via the telecommunication network, the first message containing a request originated by the first UE 2 and requesting status information relating to the second UE 8. The first message is processed by the MIH client 6. The processing includes sending the message using the MIH client 6 to an entity that has an MIHF ID, the entity being the MIH client 10 of the second UE 8 in the first embodiment.

To explain this with reference to FIG. 1B, in step 110, user B of the second UE is located in a roaming area.

In step 112, a Visitor Location Register (VLR) sets the roaming status of user B in a Home Location Register (HLR) representing the location of user A.

In step 114, user B determines if address information, i.e., an MIHF ID, which is typically a telephony party identifier such as a telephone number relating to a user and/or UE, is obtained on the UE of user A. The MIHF ID may be an address book kept in the first UE of user A.

Consequently, when the user B includes the MIHF ID in the first UE of user A, the procedure proceeds to step 116, and the user status on the UE of user B is set to a roaming status.

On the contrary, when the user B does not include the MIHF ID, the procedure proceeds to step 118 and information about the user status relating to roaming setting is not modified.

The trigger for sending the first message may be based on the dwell time of browsing through the address book, so that status information may be sought only for those entries on which User A pauses for longer than a threshold time, to avoid unnecessary demands on signaling resource for retrieving status information.

In response to the first message, a second message is received via the telecommunication network, the second message conveying the requested status information to the first UE 2 and the second message being sent in this embodiment from the MIH client 10 of the second UE 8 to the MIH client 6 of the first UE 2.

The status information may then be displayed on the first UE to user A, so that user A can make an informed decision of whether to call user B.

The status information may include data indicating a location of the second UE, a time of day at the location of the second UE, an indication of whether the second UE is registered to a wireless network other than a home wireless network for the second UE, and/or a type of network to which the second UE is connected.

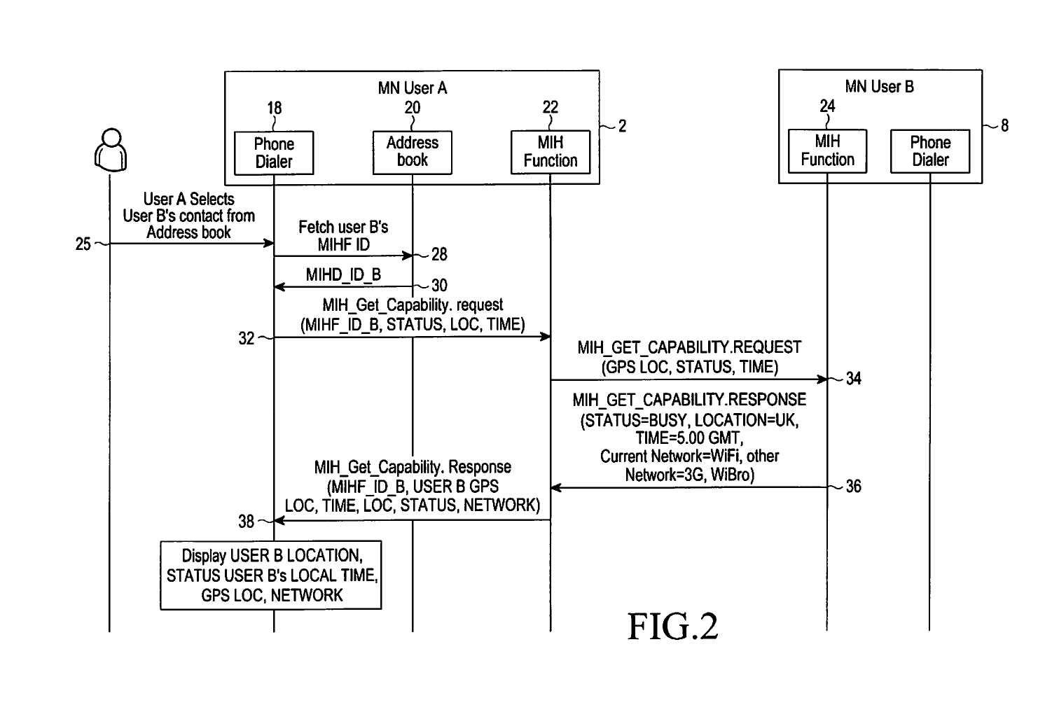

FIG. 2 illustrates an exchange of signaling in the first embodiment of the invention. The first UE 2 is also referred to as the Mobile Node of User A (MN User A). Within the first UE, there is shown a phone dialer 18, an address book 20, and a MIHF 22, the MIHF being the entity of the MIH client 6 that sends and receives messages. The second UE 8 has a MIHF 24. Firstly, user A selects contact details relating to user B or the second UE 8 from the address book. Then, the phone dialer 18 sends a message 28 to the address book 20 to fetch user B′s MIHF ID (MIHF ID), that is to say the MIHF ID for the second UE 8. In response, the address book sends a message 30 to the phone dialer supplying User B's MIHF ID, if available. If an MIHF ID is available for user B, the phone dialer then sends a message 32 to the MIHF 22 requesting status information regarding the second UE 8. In response, the MIHF 22 sends a first message 34 requesting status information relating to the second UE to the MIHF 24 of the second UE.

In response, the MIHF 24 of the second UE sends a second message 36 conveying the requested status information to the MIHF 22 of the first UE. The MIHF 22 then sends a message 38 to the phone dialer 18 conveying the requested status information. The status information is then displayed at the first UE, in order to allow a user of the first UE to decide whether or not to contact the second UE.

In the first embodiment of the invention, the first message 34 is a modified version of a MIH Capability Request Message, conventionally used for the MIH Information Service, but in this embodiment, the message is modified to carry parameters relating to the status of the second UE, and in this embodiment the message is sent to the MIHF 24 in the second UE rather than to the MIH information server. The location information may be provided by a navigation system such as GPS at the second UE.

If there is no MIHF ID stored in the address book for the entry for User B relating to the second UE, then the first message 34 is not sent. Also, if the first UE is not equipped with a MIH client, then the first message is not sent. In either case, therefore, the status information may not be available at the first UE.

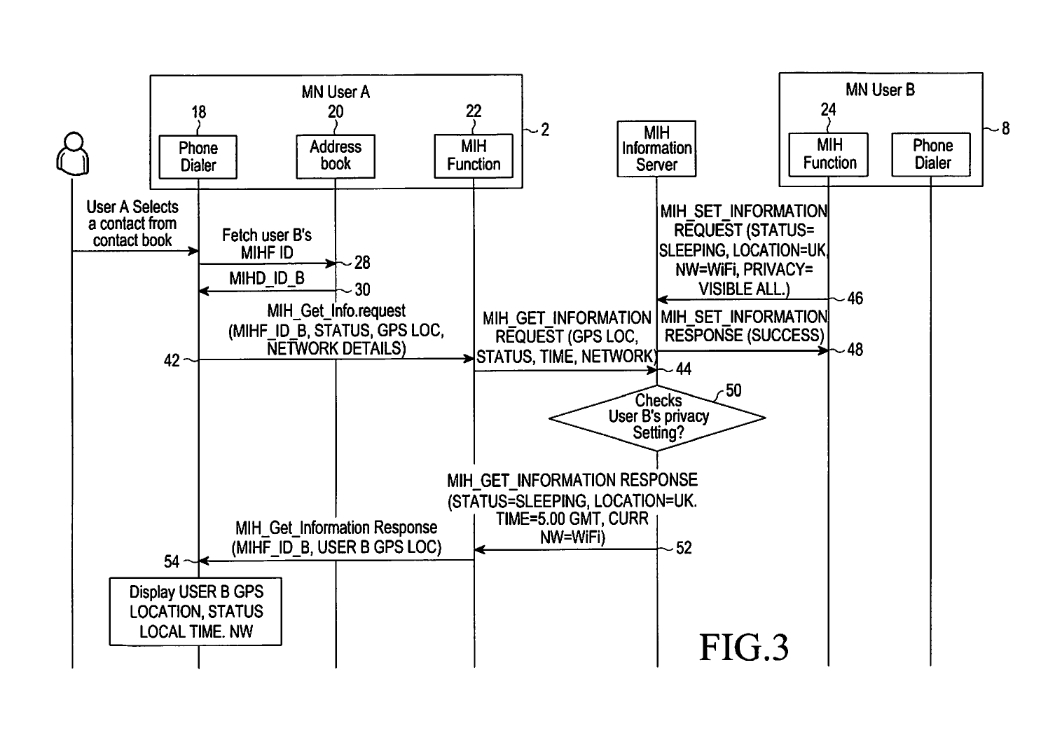

FIG. 3 illustrates an exchange of signaling in a second embodiment of the invention. As in the first embodiment, user A selects user B's contact details from the address book, the phone dialer 18 sends a message 28 to the address book 20 to fetch user B's MIHF ID, and in response, the address book sends a message 30 to the phone dialer supplying User B's MIHF ID, if available. In the second embodiment, the phone dialer then sends a message 42 to the MIHF 22 requesting status information regarding the second UE 8. In response, the MIHF 22 sends a variant 44 of the first message requesting status information relating to the second UE to the MIH Information server 16. The status information regarding the second UE is held on the MIH information server in this embodiment; the status information is updated by means of a message 46 sent to the MIH information server by the MIHF 24 installed in the second UE, and the MIH server is arranged to send an acknowledgement 48.

In response to receiving the message 44 requesting status information, the MIH Information server 16 checks user B's privacy settings 50, the privacy setting relating to permission to pass the status information to user A. Provided that the privacy settings allow, the MIH server sends a variant 52 of the second message conveying the requested status information to the MIHF 22 of the first UE. The MIHF 22 then sends a message 54 to the phone dialer 18 conveying the requested status information. The status information is displayed at the first UE, in order to allow a user of the first UE to decide whether or not to contact the second UE.

In the second embodiment of the invention, the variant 44 of the first message is a modified version of a MIH Get Information Request Message, conventionally used for the MIH Information service, modified to carry parameters relating to the status of the second UE.

Similarly to the case of the first embodiment, if there is no MIHF ID stored in the address book for the entry for User B relating to the second UE, then the variant 44 of the first message is not sent. Also, if the first UE is not equipped with a MIH client, then the first message is not sent. In either case, therefore, the status information may not be available at the first UE.

A third embodiment of the invention concerns avoidance of an inconvenient alert relating to the delivery of a payload message, such as a Short Message Service (SMS) or Multimedia Messaging Service (MMS) message, to the second UE. This is achieved by delaying the transmission of the payload message from the first UE, if processing of status information relating to the second use equipment indicates that delivery of the message would cause an inconvenient alert. The duration of the delay may depend on the status information.

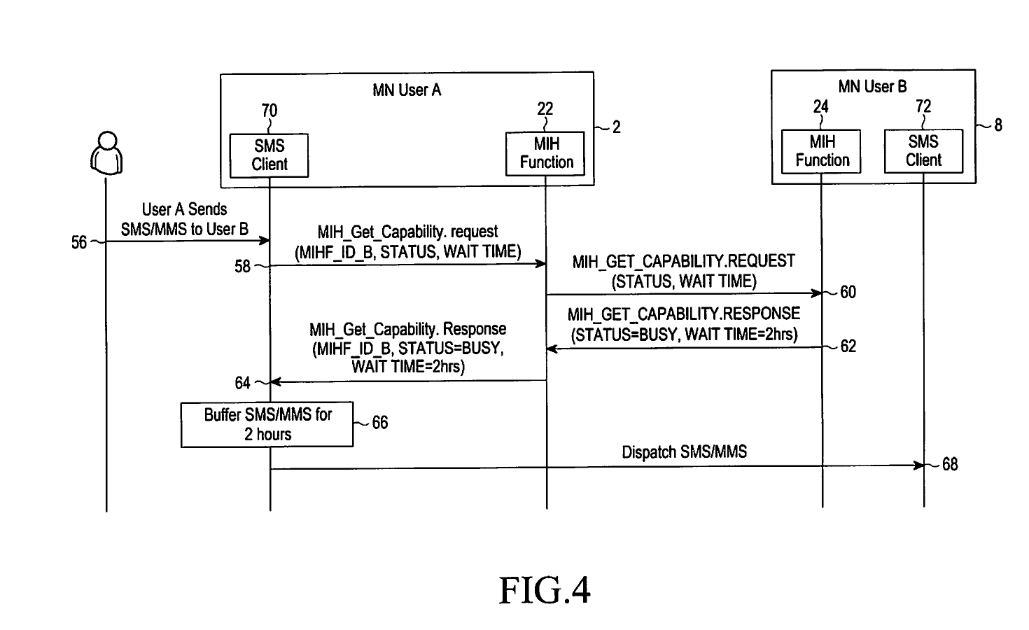

FIG. 4 illustrates an exchange of signaling in the third embodiment of the invention, operating in the telecommunications network of FIGS. 1A and 1B. User A of the first UE 2 initiates the sending of a payload message to the second UE 8, used by user B, using an SMS client 70 installed in the first UE 2. In response to the initiation of the sending of the payload message, a MIHF ID related to the second UE is requested from an address store, that may be an address book held on the first UE. If there is no MIHF ID available for the second UE, then the payload message is sent to the second UE. If an MIHF ID is available for the second UE, then the SMS client 70 sends a message 58 to the MIHF 22 of the first UE, requesting status information regarding the second UE 8. In response, the MIHF 22 sends a first message 60 requesting status information relating to the second UE to the MIHF 24 of the second UE.

In response, the MIHF 24 of the second UE sends a second message 62 conveying the requested status information to the MIHF 22 of the first UE. The MIHF 22 then sends a message 64 to the SMS client conveying the requested status information.

As a variant, the status information may be retrieved from the MIH server 16 using similar messaging to that in the second embodiment.

The requested status information is processed at the first UE to determine whether an inconvenient alert may be caused by sending the payload message, and if so, by how much the message should be delayed. Dependent on the determination, the payload message may be stored 66 at the first UE and after a determined delay, the payload message is sent to the SMS client 72 of the second UE 8.

In a fourth embodiment of the invention, a method is provided to allow a caller from a first UE to abort a call to a second UE, in response to status information relating to the second UE conveyed in an alerting tone played to the caller. This is achieved by delaying the generation of an alert for use at the second UE dependent on the status information, in order to allow the caller to decide whether or not to abort a call to the second UE before the generation of an alert at the second UE.

This method is particularly applicable when either the first or second UE, or both, does not have a MIH client, so that communication of the status information using MIH clients, according to the first and second embodiments, is not available.

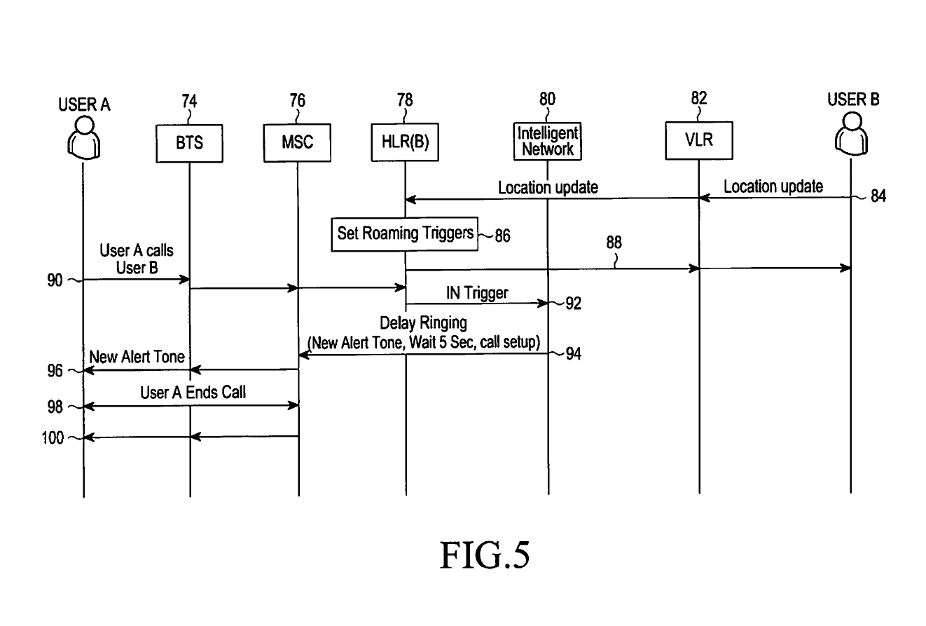

FIG. 5 shows an exchange of signaling in the fourth embodiment of the invention; for the purposes of illustration this is shown in the context of a Circuit Switched telecommunication network comprising GSM RANs. Alternatively, this may be implemented in the context of the IP Multimedia Subsystem in UMTS or LTE using the Customized Alerting Tone feature to communicate the status and preference of the second user. In this example, user A is a user of a first UE which is camped in a GSM RAN, and is in communication with a Base Transceiver Station (BTS) 74 which is itself in communication with a Mobile Switching Center (MSC) 76. User B is a user of a second UE that is roaming away from its home network. The second UE sends an update 84 to the second UE's Home Location Register (HLR) indicating the location of the second UE. The location update may be sent via the Visitor Location Register 82 of a network into which it has roamed. In response to the update, roaming triggers are set 86 at the HLR of the second UE. An acknowledgement 88 is sent to the second UE.

A message 90 initiating the call is sent from the first UE via Base Transceiver Station 74 and mobile Switching Center 76 to the second UE's Home Location Register 78. Upon receiving the message initiating the call to the second UE, and depending on the setting of the roaming triggers 86 relating to the second UE, the Home Location Register generates an Intelligent Network (IN) trigger that is sent to an Intelligent Network node 80 in the telecommunication network. Depending on the location update, the Intelligent Network 80 communicates to the Mobile Switching Center 76, which may send an alerting tone to the first UE communicating the status of the second UE to the user of the first UE. The status may relate to roaming status of the second UE, that is to say whether the second UE is registered to a wireless network other than a home wireless network for the second UE. The alerting tone may be a distinctive sound such as a musical passage or may be a voice message or other sound. The status may also relate to the location of the second UE, or to the time of day at the location of the second UE.

A status indicator may be set on the basis of the status of the second UE, and the status indicator may for example be set at the intelligent network. The status indicator may comprise status data indicating a contactability preference setting for the second UE, for example indicating that the user of the second UE wishes to receive only urgent personal calls. Dependent on the status indicator, an alerting tone is selected or generated for use at the first UE and the generation of an alert for use at the second UE is delayed, so for example ringing is delayed. The delay of the alert tone may be achieved for example by delaying the call set up at the Mobile Switching Center 76, or by simply delaying the generation of an alert at the handset of User B following reception of a call set up message. The caller may then decide whether or not to abort the call to the second UE before the generation of the alert at the second UE.

In the case that the first UE does have a MIH client, and the second UE does not, the process of initiating a call may proceed as follows. User A selects the entry for user B from an address book, but user B does not have a MIHF ID stored. Therefore, the message from the first UE requesting status information relating to the second UE is not sent using the MIH client, as there is likely to be no MIH client at the second UE.

A message may be displayed at the first UE to the effect that the status information relating to the second UE is not available. A message may also be displayed indicating that, should the call be initiated, an alerting tone may be played if the call is likely to be inconvenient and the caller will be given the chance to abort the call before the called party is disturbed by an alert.

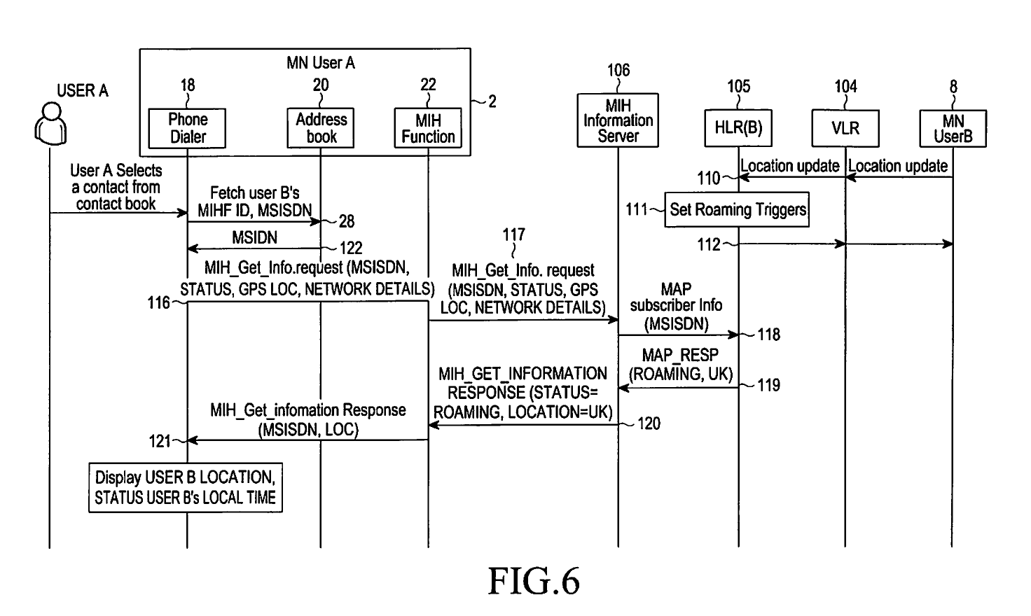

FIG. 6 shows an exchange of signalling in a fifth embodiment of the invention. The first UE 2 is also referred to as the Mobile Node of User A (MN User A). Within the first UE 2 there is shown a phone dialer 18, an address book 20, and a MIHF 22, the MIHF being the entity of the MIH client 6 that sends and receives messages. In a hybrid network, a UE may or may not have an MIH client. FIG. 6 relates to an example of operation in a hybrid network, in which the first UE 2 has a MIH client and the second UE 8 does not have a MIH client.

When the second UE 8 is roaming, the second UE 8 sends an update 110 to the second UE's Home Location Register (HLR) 105 indicating the location of the second UE 8. The location update may be sent via the Visitor Location Register 104 of a network into which it is roaming. In response to the update 110, roaming triggers are set 111 at the HLR 105 of the second UE 8. An acknowledgement 112 is sent to the second UE 8.

User A, being the user of the first UE 2, intends to call user B, who is the user of the second UE 8. At this point, user A would like to obtain status information regarding the second UE 8. User A is not aware of the location or time zone in which the second UE 8 is located and wants to avoid causing an inconvenient alert to user B.

User A selects an entry for user B from an address book 108, which stores address information, typically at the first UE 2. The address information may, in an alternative embodiment, be retrieved from other entities in the telecommunication network. The address information conventionally comprises a telephony party identifier such as a telephone number that may be a Mobile Subscriber ISDN Number (MSISDN), relating to a user and/or a UE. According to the fifth embodiment of the invention the address book may also hold MIHF identifiers relating to UE and/or the user in addition to the telephony party identifier. The phone dialer 18 sends a message 28 to the address book 20 to fetch user B's MIHF ID, that is to say the MIHF ID for the second UE 8. Attempting to retrieve the MIHF ID from the address book has the function of indicating whether the UE to be called has a MIH client installed. In this example, the second UE 8 does not have a MIH client installed, and so, no MIH identifier is retrieved. A message 122 is sent from the address book 20 to the phone dialer 18 conveying the MSISDN.

A message 116 requesting the status information regarding the second UE is generated at the phone dialer 18, sent to the MIHF 22 and forwarded to the MIH information server. Then, the status information 118 containing the MSISDN number is sent by the MIH Information Server 106 to the HLR 105 as a Mobile Application Part (MAP) subscriber info. The approximate location of the user, based on the VLR location of the user and the roaming status is retuned as a MAP message 119.

The status is updated by means of a message 120 sent from the MIH information server to the MIHF 22 installed in the first UE 2. The status information is then displayed at the first UE, in order to provide the user A of the first UE 2 with enough information to decide whether or not to contact the second UE 8.

The above embodiments are to be understood as illustrative examples of the invention. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims and their equivalents.

What is claimed is:

1. A method of processing User Equipment (UE) status information in a telecommunication network including a plurality of Radio Access Networks (RANs), first UE and second UE, the method comprising:
sending a first message via the telecommunication network, the first message containing a request originated by the first UE and requesting status information relating to the second UE; and
receiving a second message via the telecommunication network, the second message conveying the requested status information,
wherein at least one of said first and second messages are processed using a service component which is used for controlling handover of UE between different RANs.

2. The method of claim 1, wherein the service component is a Media Independent Handover (MIH) client on the first UE.

3. The method of claim 2, wherein the first message is sent from an MIH client on the first UE to an MIH client on the second UE and the second message is received at the MIH client on the first UE from the MIH client on the second UE.

4. The method of claim 2, wherein the first message is sent from an MIH client on the first UE to an MIH server in the telecommunication network and the second message is received at the MIH client on the first UE from the MIH server.

5. The method of claim 1, wherein the requested status information includes status data indicating a location of the second UE.

6. The method of claim 1, wherein the status information conveyed in the second message comprises:
status data indicating: a time of day at the location of the second UE, contactability preference setting for the second user; whether the second UE is registered with a wireless network other than a home wireless network; and a type of a network to which the second UE is connected.

7. The method of claim 1, further comprising:
sending the first message dependent on a determination that the second UE has an associated Media Independent Handover (MIH) function identifier.

8. The method of claim 1, further comprising:
providing an indication relating to said requested status information at the first UE, in order to allow a user of the first UE to decide whether or not to contact the second UE.

9. The method of claim 1, further comprising:
dependent on the status information, storing a payload message in the first UE, and sending the payload message to the second UE after a delay in order to delay an alert by the second UE.

10. The method of claim 9, wherein the delay is dependent on the user status information conveyed in the second message.

11. The method of claim 9, wherein the payload message is an SMS or MMS message.

12. A method of managing alerts in a telecommunications network, the method comprising:
setting a status indicator relating to second User Equipment (UE);
detecting initiation of a call to the second UE by a caller from first UE;
dependent on the status indicator, selecting an alerting tone for use at the first UE; and
dependent on the status indicator, delaying generation of an alert for use in the second UE in order to allow the caller to decide whether or not to abort the call to the second UE before generating the alert in the second UE.

13. The method of claim 12, wherein the status indicator indicates status information comprising status data indicating whether the second UE is registered to a wireless network other than a home wireless network for the second UE.

14. The method of claim 13, wherein the method comprises setting the status indicator dependent on a query to a home location register associated with the second UE.

15. The method of claim 12, wherein the status indicator comprises status data indicating a location of the second UE, a time of day at the location, and contactability preference setting.

16. A method in a telecommunications system, comprising the steps of:
setting a status indicator relating to second User Equipment (UE);
detecting initiation of a call to the second UE by a caller from first UE;
selecting an alerting tone for use in the first UE, dependent on the status indicator; and
delaying generation of an alert for use in the second UE in order to allow the caller to decide whether or not to abort the call to the second UE before generating the alert in the second UE, depending on the status indicator.
